(19) United States
(12) Patent Application Publication
(10) Pub. No.: US 2018/0019589 A1
(43) Pub. Date: Jan. 18, 2018

(54) FAULT CURRENT LIMITER

(71) Applicant: GRIDON LTD., Givatayim (IL)

(72) Inventors: Dvir Landwer, Givatayim (IL); Uri Garbi, Givatayim (IL); Vladimir Rozenshtein, Givatayim (IL); Alex Oren, Givatayim (IL)

(73) Assignee: GRIDON LTD., Givatayim (IL)

(21) Appl. No.: 15/546,973

(22) PCT Filed: Jan. 31, 2016
(86) PCT No.: PCT/IL2016/050101

§ 371 Date: Jul. 27, 2017

(30) Foreign Application Priority Data
Jan. 30, 2015 (GB) 1501606.6
May 7, 2015 (GB) 1507840.5

(51) Int. Cl. H02H 9/02; H01F 27/42; H01F 27/29

(52) U.S. Cl. CPC H02H 9/021; H01F 27/29; H01F 27/42

(57) ABSTRACT

The present invention provides a fault current limiter apparatus comprising: a fault current limiter including: a magnetically saturable core, at least one AC coil wound on at least a portion of the magnetically saturable core, and a magnetic biasing arrangement for magnetically biasing at least a portion of the magnetically saturable core; a source terminal for electrically connecting the fault current limiter to a power source, and a load terminal for electrically connecting the fault current limiter to a load, wherein the at least one AC coil of the fault current limiter is electrically connected between the source and load terminals, and wherein the fault current limiter has a first inductance in normal conditions and a second inductance in fault conditions; a first capacitance electrically connected between the source and load terminals, wherein the first capacitance is electrically connected in series with the fault current limiter, and wherein the first capacitance has a capacitance that is arranged to have a reactance value that compensates for at least some of the first inductance.

The present invention relates to a fault current limiter (FCL).

Faults in electrical power systems cannot be avoided. Fault currents flowing from the sources to a location of the fault lead to high dynamical and thermal stresses being imposed on equipment e.g. overhead lines, cables, transformers and switch gears.

Conventional circuit breaker technology does not provide a full solution to selectively interrupting currents associated with such faults. The growth in electrical energy generation and consumption and the increased interconnection between networks leads to increasing levels of fault current. In particular, the continuous growth of electrical energy generation has the consequence that networks reach or even exceed the limits with respect to their short circuit withstand capability. Therefore, there is a need for devices that are capable of limiting fault currents.

Short circuit currents are rising as transmission and distribution networks expand to address increasing energy demand and connectivity of power generation and intermittent energy sources. These may result in power disruptions, equipment damage and major outages, which have been estimated to cost billions of dollars per year. In order to restrict fault current impact, utility operators have traditionally needed to resort to network segmentation and installation of expensive and lossy protection gear, such as series reactors, capacitors, high rated circuit breakers and high impedance transformers. Such solutions come at the cost of overall reduction of energy efficiency and network stability.

The use of fault current limiters (FCL) allows equipment to remain in service even if the prospective fault current exceeds it rated peak and short-time withstand current. Thus, replacement of equipment (including circuit breakers) can be avoided or postponed to a later time.

A fault current limiter (FCL) can be provided in various forms. One type of fault current limiter involves a fully magnetised (saturated) iron core. Such fault current limiters typically have one or more AC coils wound around an iron core, with the iron core being maintained in a saturated state by a DC bias coil in normal operating conditions. The AC coils are connected to the grid, and in normal conditions the iron core is kept saturated, making the FCL virtually transparent to the grid during normal operation.

In a fault condition (e.g. a short-circuit), a current surge will increase the current on the AC coil, causing desaturation of the iron core. As a result of this desaturation of the iron core, the impedance will rise, acting to limit the current on the AC coil. Various arrangements of the saturable core and AC and DC coils are possible. An example of a saturated core FCL is described in WO2007/029224. Another example of a saturated core FCL is described in WO2013/024462.

The present invention sets out to provide an FCL with improved performance compared to conventional arrangements.

According to an aspect of the present invention, there is provided a fault current limiter apparatus comprising: a fault current limiter including: a magnetically saturable core, at least one AC coil wound on at least a portion of the magnetically saturable core, and a magnetic biasing arrangement for magnetically biasing at least a portion of the magnetically saturable core; a source terminal for electrically connecting the fault current limiter to a power source, and a load terminal for electrically connecting the fault current limiter to a load, wherein the at least one AC coil of the fault current limiter is electrically connected between the source and load terminals, and wherein the fault current limiter has a first inductance in normal conditions and a second inductance in fault conditions; a first capacitance electrically connected between the source and load terminals, wherein the first capacitance is electrically connected in series with the fault current limiter, and wherein the first capacitance has a capacitance that is arranged to have a reactance value that compensates for at least some of the first inductance.

The addition of the first capacitance in series with the fault current limiter can help reduce the insertion impendence of the FCL and improve fault limiting performance. This can mean that either a given FCL can be used with a lower insertion impendence and better fault limiting performance, or a smaller FCL can be used for the same insertion impendence and fault limiting performance.

In some embodiments, the first capacitance has a capacitance that is arranged to resonate with the fault current limiter when it has the first inductance.

In some embodiments, an overvoltage protection system may be provided in parallel with the first capacitance.

In some embodiments, the fault current limiter apparatus further comprises: a second capacitance electrically connected between the source and load terminals, wherein the second capacitance is electrically connected in parallel with the fault current limiter, and wherein the second capacitance has a capacitance that is arranged to have a reactance value that corresponds to the second inductance.

The addition of the second capacitance in parallel with the fault current limiter can help improve fault limiting performance. This can mean that either a given FCL can be used with better fault limiting performance, or a smaller FCL can be used for the same fault limiting performance.

In some embodiments, an overvoltage protection system may be provided in parallel with the second capacitance.

In some embodiments, the fault current limiter apparatus further comprises a first resistance electrically connected in series and/or in parallel with the second capacitance, wherein the first resistance has a value arranged to tune the fault limitation and insertion impedance of the fault current limiter apparatus, optionally wherein the first resistance is variable.

In some embodiments, the first capacitance is electrically connected in series to the parallel connected fault current limiter and second capacitance.

In some embodiments, the second capacitance is electrically connected in parallel to the fault current limiter and the first capacitance.

In some embodiments, the magnetically saturable core comprises: a first leg; a second leg, with a first AC coil wound on the second leg; a third leg, with a second AC coil wound on the third leg, the first and second AC coils being connected in series; a fourth leg; wherein the first, second, third and fourth legs are arranged in order, wherein first ends of the first, second, third and fourth legs are joined by a first yoke and second ends of the first, second, third and fourth legs are joined by a second yoke; a magnetic biasing system arranged to produce a first closed magnetic circuit in the first leg and the second leg that has a first flux direction, and to produce a second closed magnetic circuit in the fourth leg and the third leg that has a second flux direction, wherein the first flux direction opposes the second flux direction; wherein the first and second AC coils are arranged to produce a first closed AC magnetic circuit in the second and third legs in an AC flux direction that alternates with each AC half-cycle.

In some embodiments, the first, second, third and fourth legs are orientated in the same direction, optionally wherein the first, second, third and fourth legs are arranged vertically.

In some embodiments, the first and second yokes are orientated in the same direction, optionally wherein the first and second yokes are arranged horizontally.

In some embodiments, the magnetic biasing system comprises a first DC coil wound on the first leg and a second DC coil wound on the fourth leg.

In some embodiments, the magnetic biasing system comprises a DC coil wound around the second and third legs, optionally wherein the at least one DC coil is wound around the first and second AC coils.

In some embodiments, the magnetic biasing system comprises a first DC coil wound around the second leg and a second DC coil wound around the third leg, optionally wherein the first DC coil is wound around the first AC coil and the second DC coil is wound around the second AC coil or the first AC coil is wound around the first DC coil and the second AC coil is wound around the second DC coil.

In some embodiments, the fault current limiter includes: at least one first AC coil wound on at least a portion of the magnetically saturable core for a first phase of a three phase AC supply, the at least one first AC coil having the first inductance in normal conditions and the second inductance in fault conditions; at least one second AC coil wound on at least a portion of the magnetically saturable core for a second phase of the three phase AC supply, the at least one second AC coil having a third inductance in normal conditions and a fourth inductance in fault conditions; and at least one third AC coil wound on at least a portion of the magnetically saturable core for a third phase of a three phase AC supply, the at least one third AC coil having a fifth inductance in normal conditions and a sixth inductance in fault conditions; wherein the source terminal is for electrically connecting the at least one first AC coil to the first phase of the AC supply, wherein the load terminal for electrically connecting the at least one first AC coil to a load, wherein the first capacitance is electrically connected between the source and load terminals in series with the at least one first AC coil, and wherein the first capacitance has a capacitance that is arranged to have a reactance value that compensates for at least some of the first inductance; wherein the fault current limiter apparatus further comprises a second source terminal for electrically connecting the at least one second AC coil to the second phase of the AC supply, a second load terminal for electrically connecting the at least one second AC coil to a load, and a third capacitance electrically connected between the second source and load terminals in series with the at least one second AC coil, wherein the third capacitance has a capacitance that is arranged to have a reactance value that compensates for at least some of the third inductance; and wherein the fault current limiter apparatus further comprises a third source terminal for electrically connecting the at least one third AC coil to the third phase of the AC supply, a third load terminal for electrically connecting the at least one third AC coil to a load, and a fourth capacitance electrically connected between the third source and load terminals in series with the at least one third AC coil, wherein the fourth capacitance has a capacitance that is arranged to have a reactance value that compensates for at least some of the fifth inductance.

In some embodiments, the second capacitance is electrically connected between the source and load terminals in parallel with the at least one first AC coil, wherein the second capacitance has a capacitance that is arranged to have a reactance value that is arranged to correspond to the second inductance; and wherein the fault current limiter apparatus further comprises: a fifth capacitance electrically connected between the second source and load terminals in parallel with the at least one second AC coil, wherein the fifth capacitance has a capacitance that is arranged to have a reactance value that is arranged to correspond to the fourth inductance; and a sixth capacitance electrically connected between the third source and load terminals in parallel with the at least one third AC coil, wherein the sixth capacitance has a capacitance that is arranged to have a reactance value that is arranged to correspond to the sixth inductance.

By arranging the first to third AC coils (or sets of coils for each AC phase) in an unbalanced (i.e. asymmetric) way, when compared to a symmetrical arrangement, the insertion impedance of the FCL is worse but the three phase fault limitation is better. In such arrangements, there is therefore a trade-off between asymmetry and insertion impedance. By using such an arrangement with series and/or parallel capacitors as described above, the insertion impedance is improved. This can allow for a greater degree of asymmetry in the AC coils (and hence better three phase fault limitation) while removing (or reducing) the worsening of the insertion impedance. In such embodiments, the series and/or parallel capacitors can have different values depending on the inductances of each phase of the FCL.

According to an aspect of the invention, there is provided a fault current limiter apparatus comprising: a fault current limiter including: a magnetically saturable core, at least one AC coil wound on at least a portion of the magnetically saturable core, and a magnetic biasing arrangement for magnetically biasing the at least a portion of the magnetically saturable core; a source terminal for electrically connecting the fault current limiter to a power source, and a load terminal for electrically connecting the fault current limiter to a load, wherein the at least one AC coil of the fault current limiter is electrically connected between the source and load terminals, and wherein the fault current limiter has a first inductance in normal conditions and a second inductance in fault conditions; a first capacitance electrically connected between the source and load terminals, wherein the first capacitance is electrically connected in parallel with the fault current limiter, and wherein the first capacitance has a capacitance that is arranged to correspond to the second inductance.

The addition of the capacitance in parallel with the fault current limiter can help improve fault limiting performance. This can mean that either a given FCL can be used with better fault limiting performance, or a smaller FCL can be used for the same fault limiting performance.

In some embodiments, an overvoltage protection system may be provided in parallel with the first capacitance.

In some embodiments, the fault current limiter apparatus further comprises: a first resistance electrically connected in series and/or in parallel with the first capacitance, wherein the first resistance has a value arranged to tune the fault limitation and insertion impedance of the fault current limiter apparatus, optionally wherein the first resistance is variable.

In some embodiments, the fault current limiter apparatus further comprises: a second capacitance electrically connected between the source and load terminals, wherein the second capacitance is electrically connected in series with the fault current limiter, and wherein the second capacitance has a capacitance that is arranged to have a reactance value that compensates for at least some of the first inductance.

The addition of the capacitance in series with the fault current limiter can help reduce the insertion impendence of the FCL and improve fault limiting performance. This can mean that either a given FCL can be used with a lower insertion impendence and better fault limiting performance, or a smaller FCL can be used for the same insertion impendence and fault limiting performance.

In some embodiments, an overvoltage protection system may be provided in parallel with the second capacitance.

In some embodiments, the second capacitance has a capacitance that is arranged to resonate with the fault current limiter when it has the first inductance.

In some embodiments, the second capacitance is electrically connected in series to the parallel connected fault current limiter and first capacitance.

In some embodiments, the first capacitance is electrically connected in parallel to the fault current limiter and the second capacitance.

In some embodiments, the magnetically saturable core comprises: a first leg; a second leg, with a first AC coil wound on the second leg; a third leg, with a second AC coil wound on the third leg, the first and second AC coils being connected in series; a fourth leg; wherein the first, second, third and fourth legs are arranged in order, wherein first ends of the first, second, third and fourth legs are joined by a first yoke and second ends of the first, second, third and fourth legs are joined by a second yoke; a magnetic biasing system arranged to produce a first closed magnetic circuit in the first leg and the second leg that has a first flux direction, and to produce a second closed magnetic circuit in the fourth leg and the third leg that has a second flux direction, wherein the first flux direction opposes the second flux direction; wherein the first and second AC coils are arranged to produce a first closed AC magnetic circuit in the second and third legs in an AC flux direction that alternates with each AC half-cycle.

In some embodiments, the first, second, third and fourth legs are orientated in the same direction, optionally wherein the first, second, third and fourth legs are arranged vertically.

In some embodiments, the first and second yokes are orientated in the same direction, optionally wherein the first and second yokes are arranged horizontally.

In some embodiments, the magnetic biasing system comprises a first DC coil wound on the first leg and a second DC coil wound on the fourth leg.

In some embodiments, the magnetic biasing system comprises a DC coil wound around the second and third legs, optionally wherein the at least one DC coil is wound around the first and second AC coils.

In some embodiments, the magnetic biasing system comprises a first DC coil wound around the second leg and a second DC coil wound around the third leg, optionally wherein the first DC coil is wound around the first AC coil and the second DC coil is wound around the second AC coil or the first AC coil is wound around the first DC coil and the second AC coil is wound around the second DC coil.

In some embodiments, the fault current limiter includes: at least one first AC coil wound on at least a portion of the magnetically saturable core for a first phase of a three phase AC supply, the at least one first AC coil having the first inductance in normal conditions and the second inductance in fault conditions; at least one second AC coil wound on at least a portion of the magnetically saturable core for a second phase of the three phase AC supply, the at least one second AC coil having a third inductance in normal conditions and a fourth inductance in fault conditions; and at least one third AC coil wound on at least a portion of the magnetically saturable core for a third phase of a three phase AC supply, the at least one third AC coil having a fifth inductance in normal conditions and a sixth inductance in fault conditions; wherein the source terminal is for electrically connecting the at least one first AC coil to the first phase of the AC supply, wherein the load terminal for electrically connecting the at least one first AC coil to a load, wherein the first capacitance is electrically connected between the source and load terminals in parallel with the at least one first AC coil, and wherein the first capacitance has a capacitance that is arranged to have a reactance value that that is arranged to correspond to the second inductance; wherein the fault current limiter apparatus further comprises a second source terminal for electrically connecting the at least one second AC coil to the second phase of the AC supply, a second load terminal for electrically connecting the at least one second AC coil to a load, and a third capacitance electrically connected between the second source and load terminals in parallel with the at least one second AC coil, wherein the third capacitance has a capacitance that is arranged to have a reactance value that is arranged to correspond to the fourth inductance; and wherein the fault current limiter apparatus further comprises a third source terminal for electrically connecting the at least one third AC coil to the third phase of the AC supply, a third load terminal for electrically connecting the at least one third AC coil to a load, and a fourth capacitance electrically connected between the third source and load terminals in parallel with the at least one third AC coil, wherein the fourth capacitance has a capacitance that is arranged to have a reactance value that is arranged to correspond to the sixth inductance.

In some embodiments, the second capacitance is electrically connected between the source and load terminals in series with the at least one first AC coil, and wherein the second capacitance has a capacitance that is arranged to have a reactance value that compensates for at least some of the first inductance; wherein the fault current limiter apparatus further comprises: a fifth capacitance electrically connected between the second source and load terminals in series with the at least one second AC coil, wherein the fifth capacitance has a capacitance that is arranged to have a reactance value that compensates for at least some of the third inductance; and a sixth capacitance electrically connected between the third source and load terminals in series with the at least one third AC coil, wherein the sixth capacitance has a capacitance that is arranged to have a reactance value that compensates for at least some of the fifth inductance.

According to an aspect of the invention, there is provided a fault current limiter system comprising: n fault current limiter apparatuses according to any one of the above mentioned embodiments, wherein the source terminal of each fault current limiter apparatus is for electrical connection to a different phase AC source.

In some embodiments, there are first to third such limiter apparatuses, each connected to a different phase of a three phase AC source. In some such embodiments, the fault current limiters of the first, second and third fault current limiter apparatuses are arranged in vertically or horizontally in a same tank.

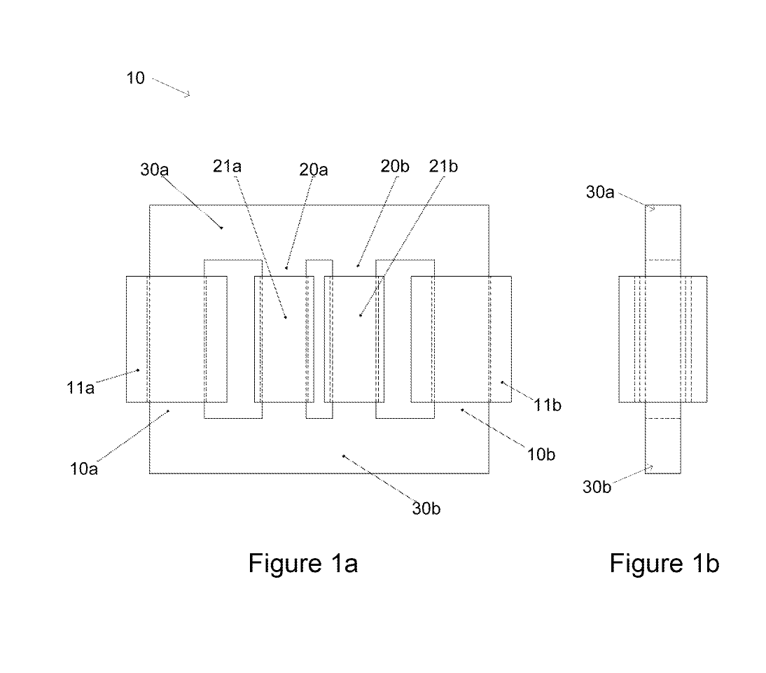

FIGS. 1a and 1b show an FCL for use in embodiments of the invention;

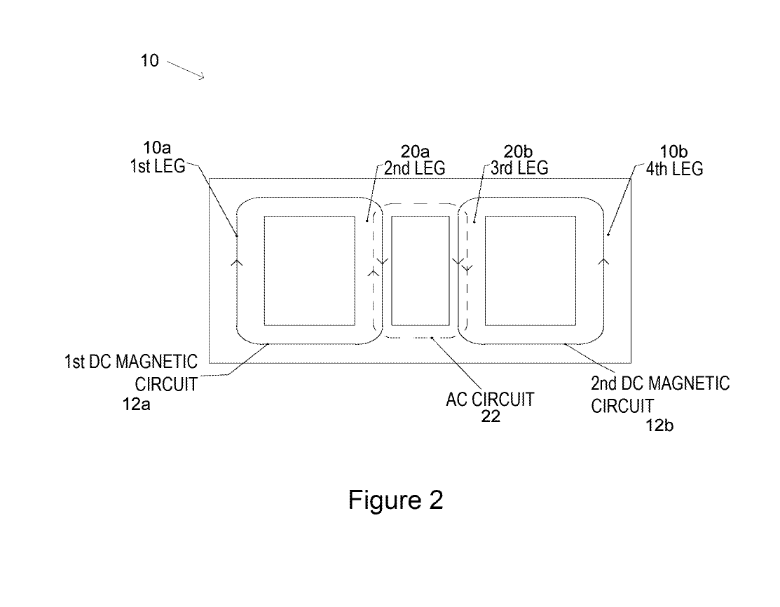

FIG. 2 shows a schematic illustration of the magnetic circuits produced in the FCL of FIG. 1;

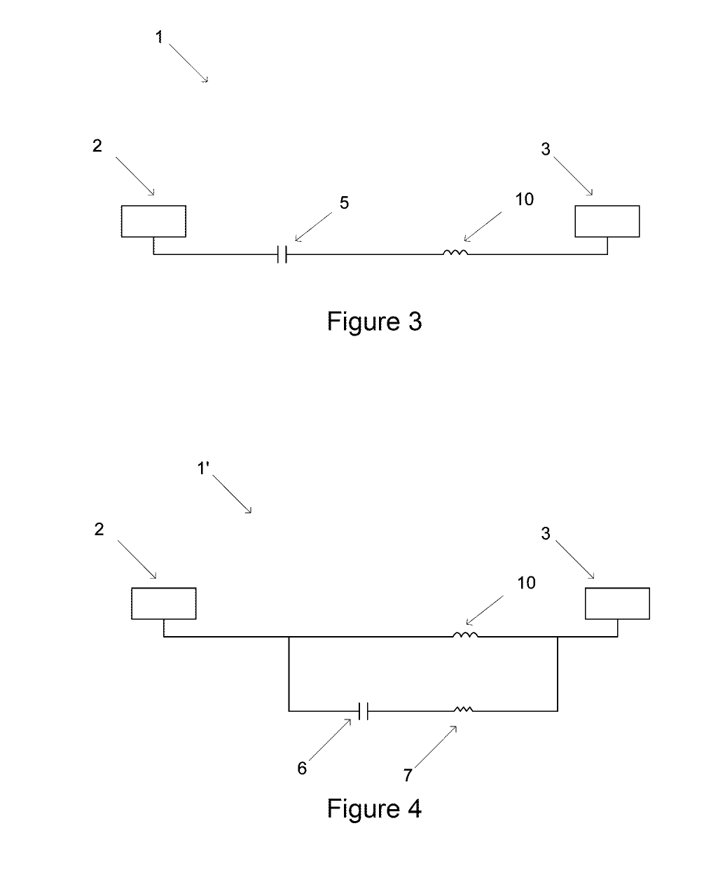

FIG. 3 shows a schematic illustration of an FCL apparatus according to a first embodiment;

FIG. 4 shows a schematic illustration of an FCL apparatus according to a second embodiment;

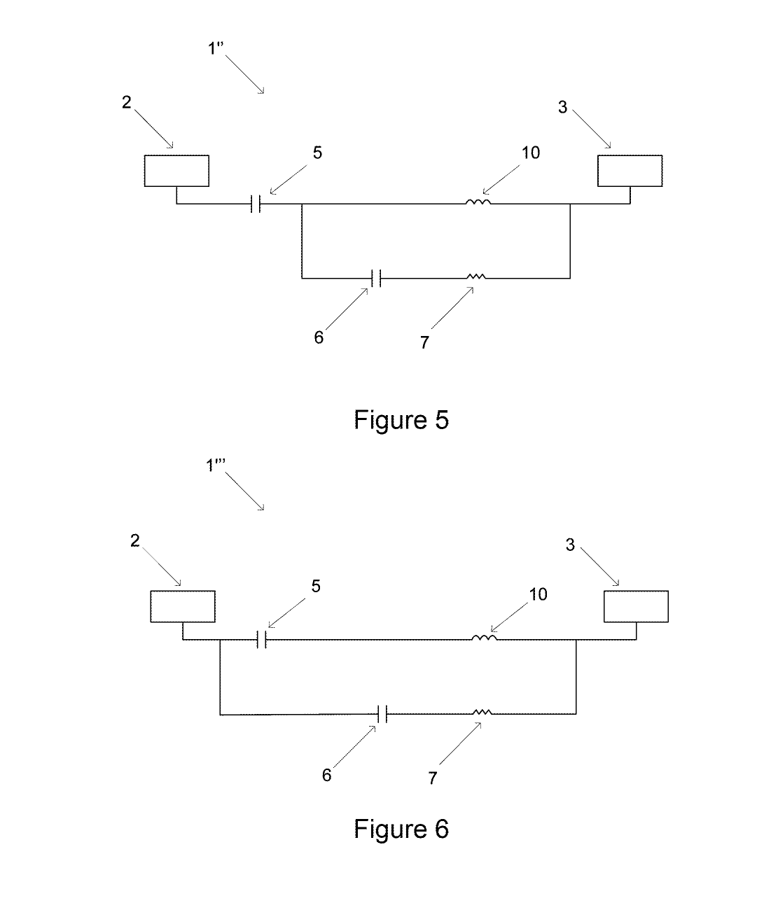

FIG. 5 shows a schematic illustration of an FCL apparatus according to a third embodiment;

FIG. 6 shows a schematic illustration of an FCL apparatus according to a fourth embodiment;

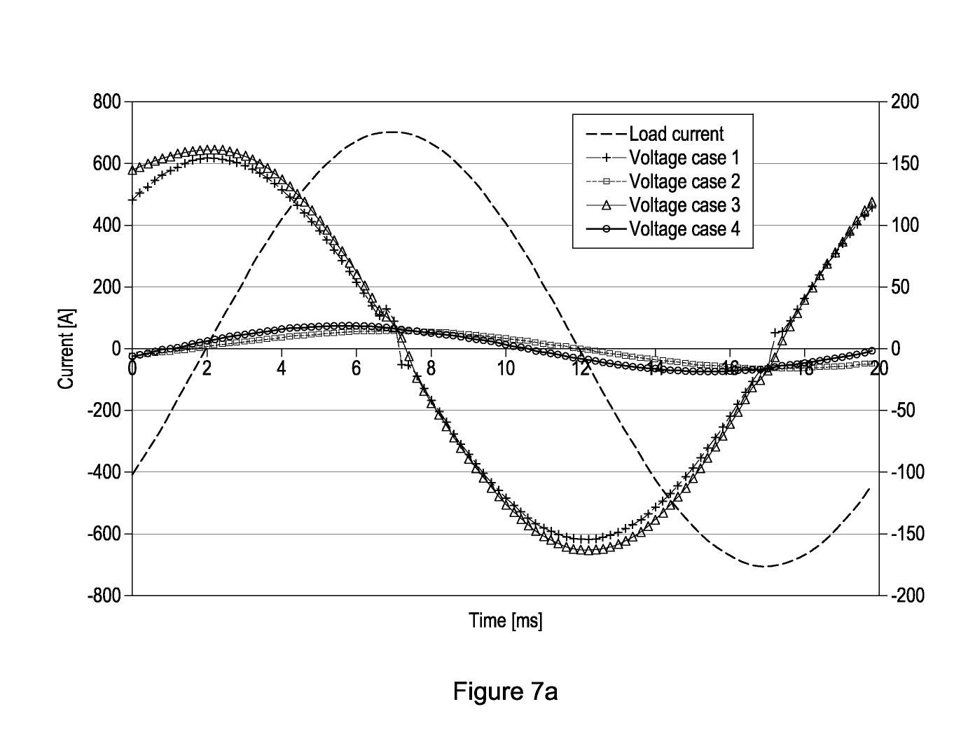

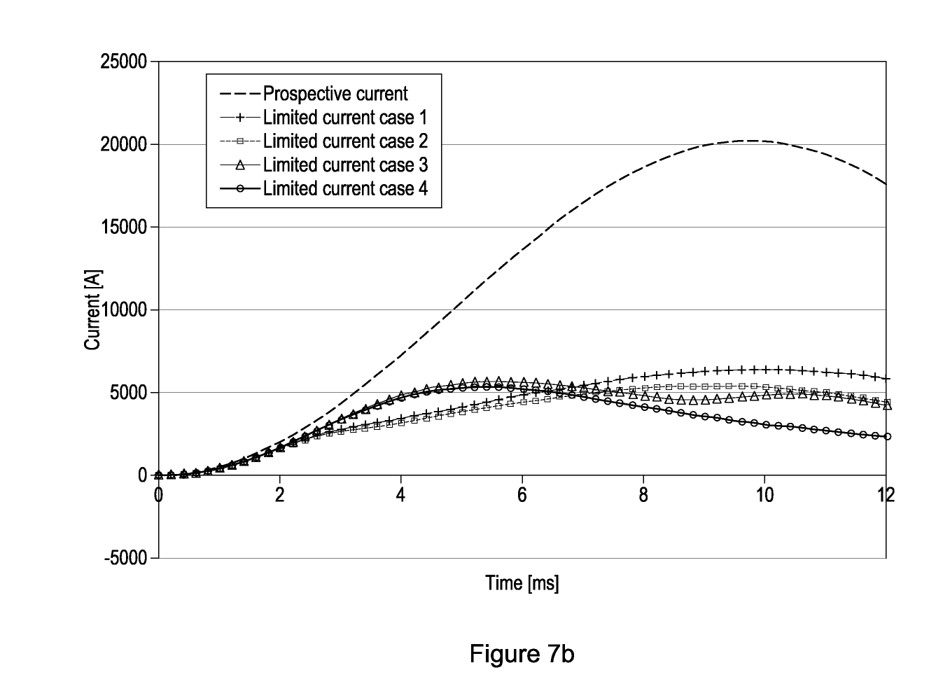

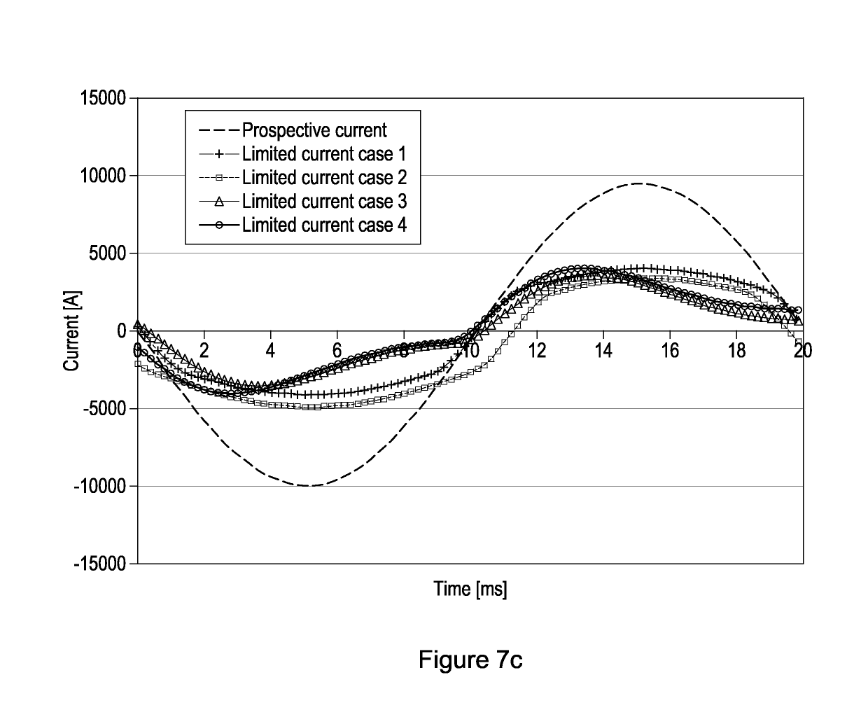

FIG. 7a shows a graph of current against time under normal conditions and voltage drop;

FIG. 7b shows a graph of current against time for a maximum asymmetry fault condition (short circuit);

FIG. 7c shows a graph of current against time under steady state fault conditions (short circuit);

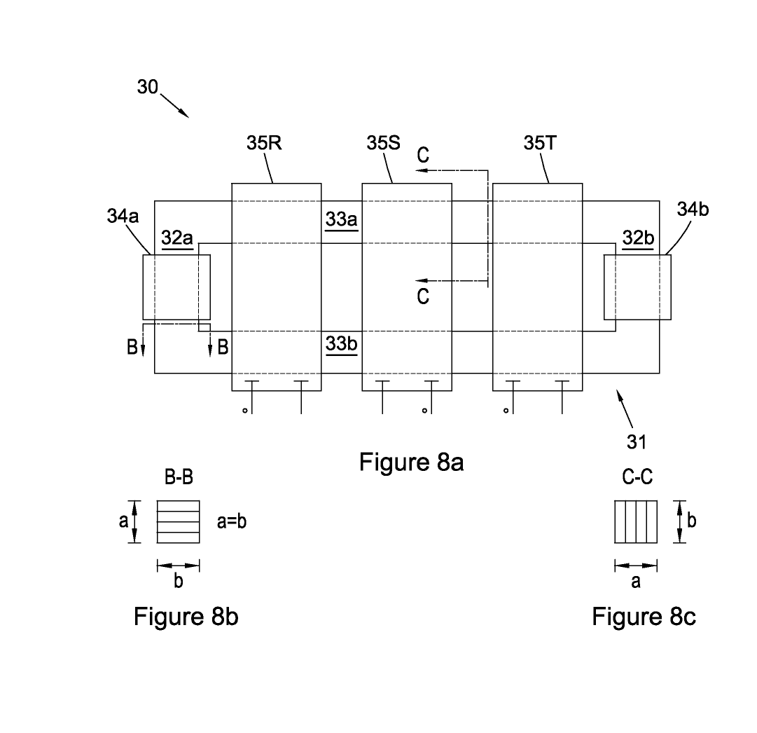

FIGS. 8a, 8b and 8c show an alternative FCL for use in embodiments of the invention;

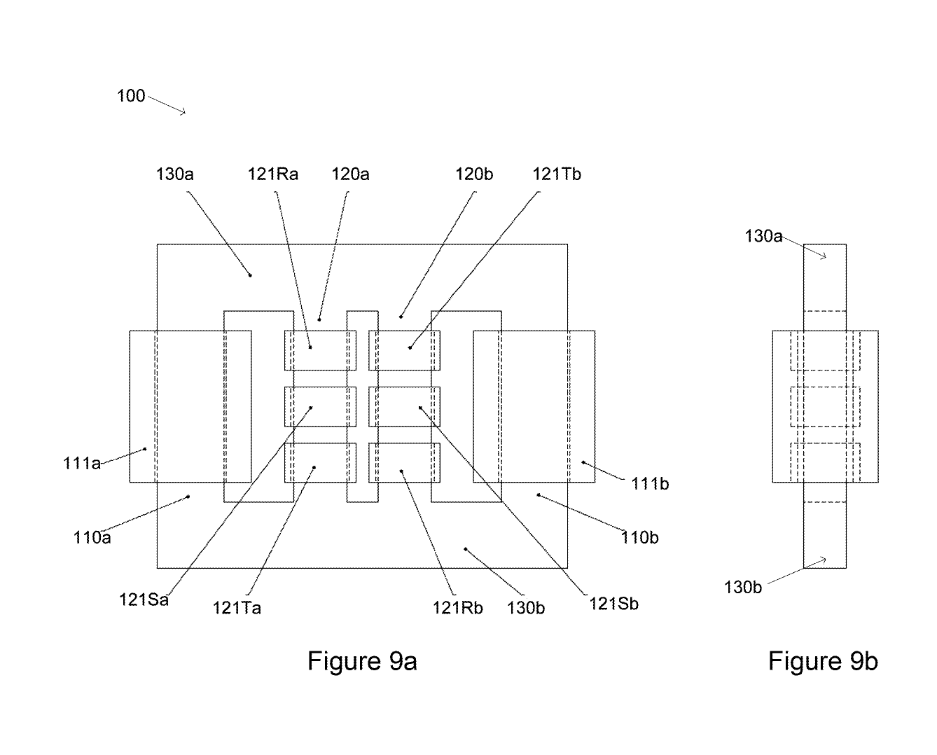

FIGS. 9a and 9b show a further alternative FCL for use in embodiments of the invention;

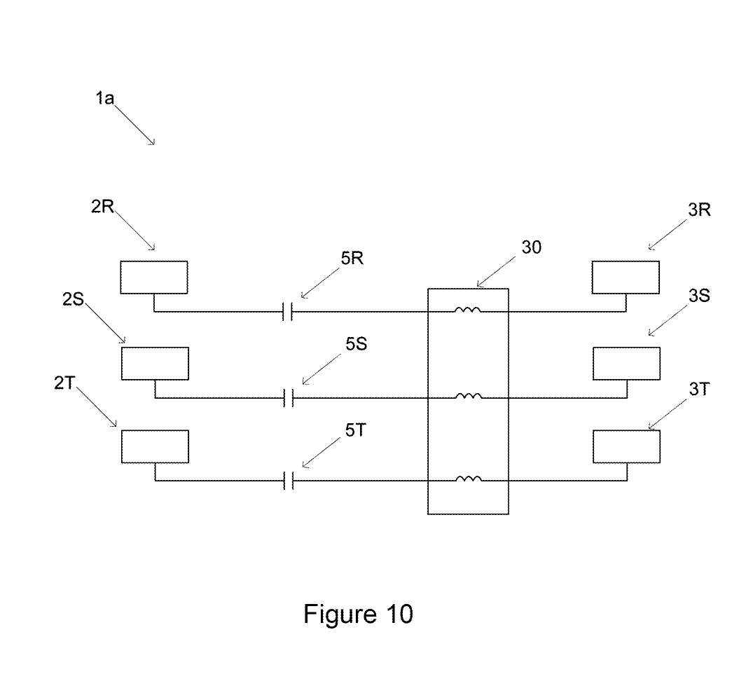

FIG. 10 shows a schematic illustration of an FCL apparatus according to a fifth embodiment;

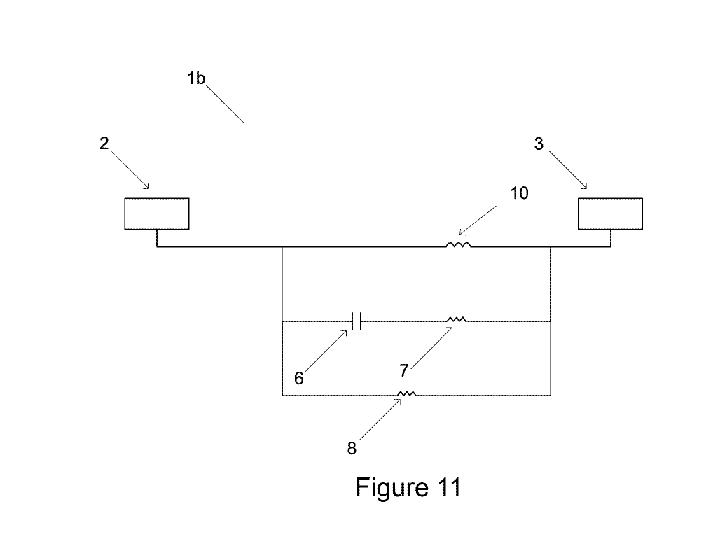

FIG. 11 shows a schematic illustration of an FCL apparatus according to a sixth embodiment;

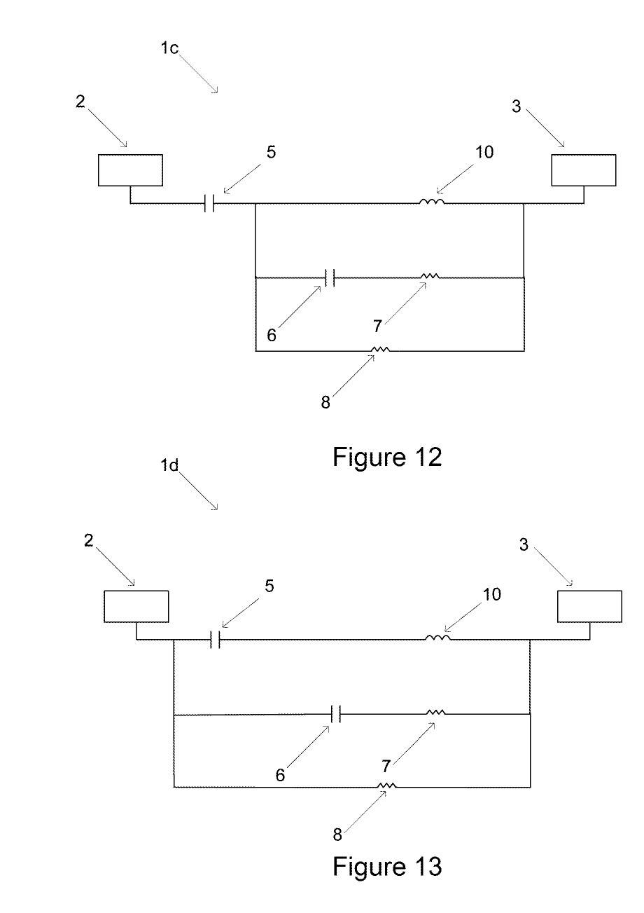

FIG. 12 shows a schematic illustration of an FCL apparatus according to a seventh embodiment;

FIG. 13 shows a schematic illustration of an FCL apparatus according to an eighth embodiment;

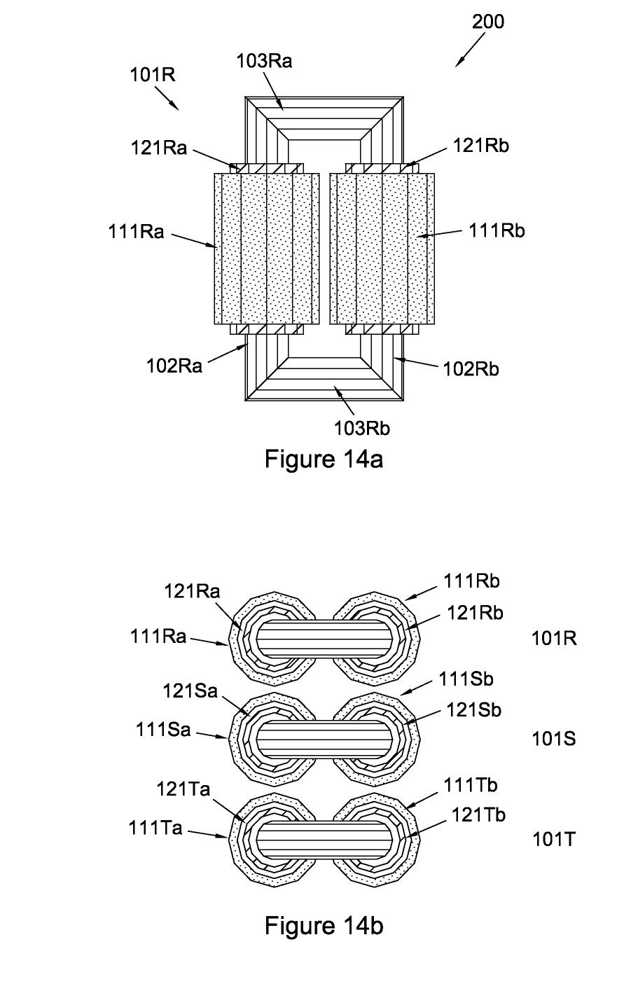

FIGS. 14a and 14b show a further alternative FCL for use in embodiments of the invention; and

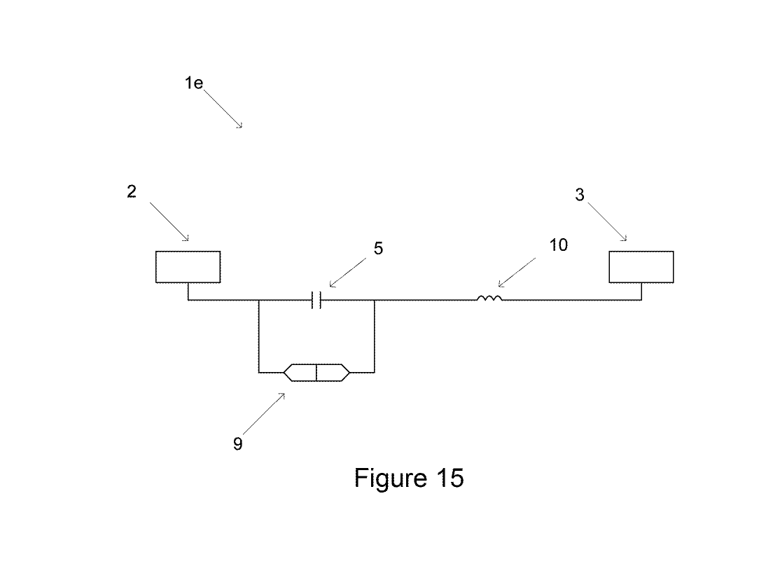

FIG. 15 shows a schematic illustration of an FCL apparatus according to a ninth embodiment.

FIGS. 1a and 1b show an FCL of a type disclosed in WO2013/024462. In this arrangement, the FCL 10 has a single core, and the FCL 10 is arranged to limit fault currents for a single phase AC supply. FIG. 1a shows a front view, whereas FIG. 1b shows a side view.

As shown in FIG. 1a, the FCL 10 has a single core that includes four legs 10a, 20a, 20b and 10b aligned in the same direction. The four legs are joined by a first yoke 30a at one end, and by a second yoke 30b at the other end. In this embodiment, the four legs 10a, 20a, 20b and 10b are aligned vertically, with the two yokes 30a, 30b aligned horizontally.

A first DC coil 11a is wound around the first leg 10a, and a second DC coil 11b is wound around the fourth leg 10b. Hence, a DC coil is wound around each of the two outer legs 10a and 10b.

A first AC coil 21a is wound around the second leg 20a, and a second AC coil 21b is wound around the third leg 20b. The AC coils 21a and 21b are connected in series, and are connected to the grid. Hence, the two AC coils 21a and 21b are wound around in series around the inner legs.

The DC coils 11a and 11b are wound so that the flux produced by the DC coils in the outer two legs has the same direction. The AC coils are wound such that the flux produced by the AC coils in the inner two legs supports the DC flux in one AC leg and opposes the DC flux in the other AC leg. Hence, the arrangement of FIG. 1 has a closed magnetic loop for the DC flux and a closed magnetic loop for the AC flux. This is shown FIG. 2, which schematically shows the magnetic circuits produced by the DC and AC coils. The coils themselves are not shown in FIG. 2, for ease of illustration.

As shown in FIG. 2, the first DC coil 11a produces a first DC magnetic circuit 12a in a closed group around the first leg 10a and the second leg 20a. The second DC coil produces a second DC magnetic circuit 12b in a closed loop around the fourth leg 10b and the third leg 20b. As shown in FIG. 2, the first DC magnetic circuit 12a has a clockwise DC flux direction and the second DC magnetic circuit 12b has an anticlockwise DC flux direction. Hence, the flux direction of the first DC magnetic circuit 12a opposes the flux direction of the second DC magnetic circuit 12b.

The AC coils 21a and 21b are wound such that there is a closed AC magnetic circuit 22. The direction of the flux in closed AC magnetic circuit 22 is such that the AC flux in one of the inner legs will oppose the DC flux in that leg, whereas the AC flux in the other leg will support the DC flux in that leg. The situation will reverse in the next half-cycle of the AC current.

Hence, FIG. 2 shows a snapshot in time in which the AC flux in the second leg 20a opposes the DC flux in the second leg 20a, whereas the AC flux in the third leg 20b supports the DC flux in the third leg 20b. In the next half-cycle, the direction of the AC flux will reverse (i.e. it will switch from being clockwise to anticlockwise), and the AC flux in the second leg 20a will support the DC flux in the second leg 20a, and the AC flux in the third leg 20b will oppose the DC flux in the third leg 20b.

The legs and yokes have, in this embodiment, interleaved, mitred, step-lapped joints. However, other embodiments can employ simpler arrangements, using non-mitred, butt-lapped joints. The core is built from grain-oriented sheet steel laminations, though other embodiments could use alternative core structures.

The coils (AC and DC) are made of electrolytic grade copper in this arrangement. However, other embodiments could use alternative materials for the coils.

The FCL 10 of this embodiment can further comprise a tank (not shown) arranged to house the core. The tank can be partially or completely filled with a dielectric fluid. Any suitable dielectric fluid could be used, for example mineral oil or vegetable oil (which have been found to be suitable as a dielectric for voltages up to 300 kV and beyond).

In normal conditions, the first DC coil 11a produces flux in the first DC magnetic circuit 12a that flows around the first leg 10a and the second leg 20a. The second DC coil 11b produces flux in the second DC magnetic circuit 12b that flows around the fourth leg 10b and the third leg 20b. The flux in the first DC magnetic circuit 12a flows in a different direction to the second flux in the DC magnetic circuit 12b.

At the AC current peak, the flux produced by the AC coils 21a and 21b closed AC magnetic circuit 22 is clockwise in the half cycle illustrated schematically in FIG. 2. Hence, the flux produced by the AC coil 21a in the second leg 20a opposes the DC flux produced by the first DC coil 11a in the second leg 20a, whereas the AC flux produced by the second AC coil 21b in the third leg 20b supports the DC flux produced by the second DC magnetic circuit 12b in the third leg 10b. This arrangement of the AC magnetic circuit supporting/opposing the DC magnetic circuits will reverse in the next half cycle, with the second leg 20a becoming more saturated and the third leg 20b becoming less saturated.

Under normal conditions, the second and third legs are kept in a saturated state (with one leg being more saturated than the other leg). Hence, under normal conditions, the coils around saturated legs 20a and 20b have very low impedance, and hence the FCL 10 is virtually transparent to the grid connected to the FCL 10.

In fault conditions, the magnitude of the AC flux is increased due to the higher AC current in the short circuit state. Hence, in the short circuit state, the effect of the AC magnetic circuit supporting the DC flux in one leg and opposing the DC flux in the other inner leg is magnified.

The magnification of the AC magnetic flux supporting/opposing the DC magnetic flux has the effect of, in one half cycle, putting the second leg 20a into very high saturation, whilst putting the third leg 20b into an unsaturated state. The effect of the third leg 20b being in the unsaturated state will be that the impedance of the coil on the right-hand leg will increase, acting to limit the fault current. The situation in the next AC half cycle will reverse, with the second leg 20a being put out of saturation (and hence its impedance will rise), with the third leg 20b being more saturated. Hence, during fault conditions, in every half-cycle, one of the second or third legs (i.e. the inner legs) will be out of saturation, ensuring a high impedance state. This alternation of raising impedance in the AC coils on one of the inner legs continues until the fault is cleared.

The FCL 10 therefore provides a saturated core FCL with low impedance in normal conditions and higher impedance in fault conditions. In general terms, saturated core FCLs are devices that move between two regimes of operation—normal and fault, in an automatic, passive way. The shift between these states is governed solely by the current level flowing in the AC circuit, and its ability to overcome the constant DC bias field that saturates the iron core.

As a result, it will be appreciated that it is not straightforward to achieve both low voltage drop across the FCL (i.e. low insertion impedance) during normal operation, and high fault reduction, which is synonymous with high voltage drop across the FCL.

When the highest normal current is close (e.g. 2×) to the limited fault current, the shift between the two states becomes more difficult and often drives for higher insertion impedance which is not desired, or results in lower than desired fault reduction

FIG. 3 shows a fault current limiter apparatus 1 according to a first embodiment of the invention.

In this embodiment, an FCL 10 of the type discussed above in relation to FIGS. 1 and 2 is used. However, as will be discussed further below, embodiments of the invention can use any saturated core FCL configuration.

In FIG. 3, there is shown a FCL 10, a source terminal 2 for electrically connecting the FCL 10 to a power source (not shown), and a load terminal 3 for electrically connecting the FCL to a load (not shown). In this embodiment, the AC coils 21a and 21b of the FCL 10 are electrically connected in series between the source and load terminals 2, 3. A series capacitance 5 is electrically connected between the source and load terminals 2, 3 in series with the AC coils 21a, 21b of the FCL 10.

As discussed above, in normal conditions the impedance of the FCL 10 will be low and will be higher in fault conditions. It can be considered that, in normal conditions, the FCL 10 will have a first inductance, and that the inductance of the FCL 10 will be higher in fault conditions.

The principle of operation of this embodiment is based on inductor-capacitor compensation, where the saturated core FCL is the inductor. However, unlike regular resonant (tuned) circuits, the FCL 10 has a variable inductance, which is dependent on the current level through it.

It will be appreciated that two main types of resonance exist—series resonance and parallel resonance. In series resonance, the inductor and capacitor are series connected, and at their resonance frequency—their overall impedance is zero. This is due to the fact that the energy stored in the inductor is fully transferred into the capacitor and vice versa. In parallel resonance, the inductor and capacitor are parallel connected, and at their resonance frequency—their overall impedance is infinite. Again this is due to energy exchange between the two components.

In this embodiment, the series capacitance 5 has a reactance value that corresponds to the first inductance. As a result, the series capacitance 5 will compensate for at least some of the first inductance, lowering the impendence of the fault current limiter apparatus 1.

To illustrate the effect of the series capacitance 5 in this embodiment, assume that the FCL 10 is mainly inductive during normal operation with negligible resistance for simplicity. For this example, the FCL 10 may operate in a 50 Hz system frequency and at 11 kV system voltage and 500 A normal current. Also assume that the FCL 10 was designed to achieve a 1.7% voltage drop under normal conditions, which corresponds to is an impedance of 0.218 ohm or 0.7 mHy. Applying the formulae in Equation 1, a capacitor that would compensate for this inductance is about 14.6 mF.

$${X}_{C} = \frac{1}{ω C} = {X}_{L} \to C = \frac{1}{ω {X}_{L}} = \frac{1}{2 π {fX}_{L}} \qquad Equation 1$$

where:

ω is angular frequency [rad/sec]

C is capacitance [F]

f is frequency (in this case 50 Hz)

X_{C} is capacitive reactance [Ohm]

X_{L} is inductive reactance [Ohm]

The performance of this configuration is discussed below in relation to Table 1, but it can be seen that the voltage drop in normal conditions improves from 1.72% to 0.17% (i.e. a factor of 10x) with the addition of the series capacitance 5. This improvement in performance can be translated into and FCL with significantly smaller size and weight that would still support the original requirement.

When the current level through the FCL 10 rises in fault conditions, the impedance of the FCL 10 increases rapidly as the AC flux is able to overcome the DC bias flux. Usually the increase in impedance of the FCL 10 can be in the order of 2 fold to 15 fold or higher the normal operation impedance mentioned above. When this happens, the series capacitance 5 no longer compensates for the inductance and the overall impedance of the FCL 10 and series capacitance 5 increases significantly. The addition of series capacitance changes the characteristic of the transient behaviour of the circuit and improves peak limitation in fault conditions.

As a result, the effect of the series capacitance 5 is to lower the impendence of the fault current limiter apparatus 1 in normal conditions (i.e. give a lower insertion impedance and a lower voltage drop) and to improve peak limitation in fault conditions.

FIG. 4 shows a fault current limiter apparatus 1′ according to a second embodiment of the invention.

In this embodiment, an FCL 10 of the type discussed above in relation to FIGS. 1 and 2 is used. However, as will be discussed further below, embodiments of the invention can use any saturated core FCL configuration.

In FIG. 4, there is shown a FCL 10, a source terminal 2 for electrically connecting the FCL 10 to a power source (not shown), and a load terminal 3 for electrically connecting the FCL to a load (not shown). In this embodiment, the AC coils 21a and 21b of the FCL 10 are electrically connected in series between the source and load terminals 2, 3. A parallel capacitance 6 and a resistance 7 are electrically connected between the source and load terminals 2, 3 in parallel with the AC coils 21a, 21b of the FCL 10.

As discussed above, in normal conditions the impedance of the FCL 10 will be low and will be higher in fault conditions. It can be considered that, in normal conditions, the FCL 10 will have a first inductance, and that the inductance of the FCL 10 will be higher in fault conditions. It will be appreciated that in fault conditions, the inductance of the FCL 10 will vary with the varying fault current. In this embodiment, impedance of the FCL 10 at the symmetrical rms current can be considered to be a second impedance. In other embodiments, the second impedance could be the maximum impedance, minimum impedance, average impedance or any other suitable value

In this embodiment, the parallel capacitance 6 has a reactance that corresponds to the second inductance.

As a result, under normal operating conditions the parallel capacitance 6 would have negligible influence on the overall circuit impedance, as the reactance of the parallel capacitance 6 is much higher than the first impedance of the FCL 10.

When current levels rise to fault levels, the FCL 10 significantly increases its impedance (e.g. 2 fold to 15 fold or higher its normal impedance). When this happens, the parallel capacitance 6 designed to correspond to the increased FCL fault impedance, forms a tuned circuit with very high impedance, and provides significantly increased fault limiting capability.

As known from tuned-circuits theory, the bandwidth of the high impedance operating range is governed by the losses or resistance (damping) in the circuit. As a result of the FCL inductance changing through the cycle (with current change) and not fixed being, it is therefore sometimes desired to tune the bandwidth using resistance to allow for higher or lower current limitation. In addition it could also reduce that sensitivity to frequency change during fault.

To maintain low losses and low insertion impedance during normal condition, the resistance 7 is placed in series to the parallel capacitance 7 and in parallel to the FCL 10. However, additional locations to place the resistance are possible in other embodiments of the invention.

The first resistance 7 has a value arranged to tune the fault limitation of the fault current limiter apparatus. In some embodiments, the value of the first resistance may be varied. This could also allow tuning of the fault current limitation of the FCL apparatus on site by this resistance change.

As an example, assume that the FCL 10 that operates in a 50 Hz system and at 11 kV system voltage and 500 A normal current. Also, assume that the FCL 10 was designed to provide 1.72% voltage drop under these conditions. This translates to an impedance of 0.218 ohm, or 0.7 mHy.

During the fault cycle, the instantaneous inductive reactance of the FCL could change between 0.218-5 Ohms. A parallel capacitance 6 that would enhance the performance of the FCL 10 limitation both of the initial current peak and the symmetrical rms current is 0.909 mF with addition of 1 Ohm resistance 7 in series to that parallel capacitance 6.

The performance of this configuration is shown below as Case 3 in Table 1 indicating that while the normal voltage drop has only slightly degraded from 1.7% to 1.8%. However, the current limitation is greatly improved. Initial peak limitation was improved from 68.5% to 72.0% and symmetrical (steady state) current limitation is improved from 53.1% to 66.6%. This improvement in performance can alternatively be translated into a smaller size and weight that would still support the original requirement.

FIG. 5 shows a fault current limiter apparatus 1″ according to a third embodiment of the invention.

In this embodiment, an FCL 10 of the type discussed above in relation to FIGS. 1 and 2 is used. However, as will be discussed further below, embodiments of the invention can use any saturated core FCL configuration.

In FIG. 5, there is shown a FCL 10, a source terminal 2 for electrically connecting the FCL 10 to a power source (not shown), and a load terminal 3 for electrically connecting the FCL to a load (not shown). In this embodiment, the AC coils 21a and 21b of the FCL 10 are electrically connected in series between the source and load terminals 2, 3. A series capacitance 5 is electrically connected between the source and load terminals 2, 3 in series with the AC coils 21a, 21b of the FCL 10. Furthermore, a parallel capacitance 6 and a resistance 7 are electrically connected between the source and load terminals 2, 3 in parallel with the AC coils 21a, 21b of the FCL 10. Hence, this embodiment can be considered to be a combination of the embodiments shown in FIGS. 3 and 4

In the embodiment of FIG. 5, the series capacitance 5 is electrically connected in series to the parallel connected FCL 10 and parallel capacitance 6.

To maintain low losses and low insertion impedance during normal condition, the resistance 7 is placed in series to the parallel capacitance 6 and in parallel to the FCL 10. However, additional locations to place the resistance are possible in other embodiments of the invention.

As discussed above, in normal conditions the impedance of the FCL 10 will be low and will be higher in fault conditions. It can be considered that, in normal conditions, the FCL 10 will have a first inductance, and that the inductance of the FCL 10 will be higher in fault conditions. It will be appreciated that in fault conditions, the inductance of the FCL 10 will vary with the varying fault current. In this embodiment, impedance of the FCL 10 at the symmetrical rms current can be considered to be a second impedance.

In this embodiment, the series capacitance 5 has a reactance value that corresponds to the first inductance. As a result, the series capacitance 5 will compensate for at least some of the first inductance, lowering the impendence of the fault current limiter apparatus 1 under normal current conditions. Furthermore, the parallel capacitance 6 has a reactance that corresponds to the second inductance.

Hence, in this configuration both advantages of the series and parallel capacitance connections are used. The insertion voltage drop during normal operation is reduced because of the series capacitance 5, and the initial current peak limitation is improved due to both series and parallel capacitance, and symmetrical rms current limitation is improved because of the parallel capacitance 6.

The addition of the resistance 7 can be used to control the bandwidth of the resonance to improve limitation during fault condition and reduce voltage drop during normal load conditions.

Using the same FCL 10 as previously mentioned with series capacitance 5 of 14.6 mF connected in series to paralleled FCL and capacitance 6 of 0.909 mF with 1 Ohm resistance achieved an improved voltage drop insertion during normal load conditions improved from 1.72% to 0.20%. In addition, as shown below in Table 1, there were improvements in the initial asymmetrical current peak limitation and the symmetrical rms current limitation.

FIG. 6 shows a fault current limiter apparatus 1′″ according to a fourth embodiment of the invention.

In this embodiment, an FCL 10 of the type discussed above in relation to FIGS. 1 and 2 is used. However, as will be discussed further below, embodiments of the invention can use any saturated core FCL configuration.

In FIG. 6, there is shown a FCL 10, a source terminal 2 for electrically connecting the FCL 10 to a power source (not shown), and a load terminal 3 for electrically connecting the FCL to a load (not shown). In this embodiment, the AC coils 21a and 21b of the FCL 10 are electrically connected in series between the source and load terminals 2, 3. A series capacitance 5 is electrically connected between the source and load terminals 2, 3 in series with the AC coils 21a, 21b of the FCL 10. Furthermore, a parallel capacitance 6 and a resistance 7 are electrically connected between the source and load terminals 2, 3 in parallel with the AC coils 21a, 21b of the FCL 10. Hence, this embodiment can be considered to be a combination of the embodiments shown in FIGS. 3 and 4.

In the embodiment of FIG. 6, the parallel capacitance 6 is electrically connected in parallel to the FCL 10 and the series capacitance 5.

To maintain low losses and low insertion impedance during normal condition, the resistance 7 is placed in series to the parallel capacitance 6 and in parallel to the FCL 10. However, additional locations to place the resistance are possible in other embodiments of the invention.

Fault current limiter apparatuses according to the present invention are associated with a number of benefits compared to conventional arrangements. A comparison of a fault current limiter arrangement without any capacitances (Case 1), a fault current limiter arrangement according to the first embodiment shown in FIG. 3 (Case 2), a fault current limiter arrangement according to the second embodiment shown in FIG. 4 (Case 3), and a fault current limiter arrangement according to the third embodiment shown in FIG. 5 (Case 4) is provided below in Table 1. The simulation results for the fourth embodiment shown in FIG. 6 are similar to those of the third embodiment shown in FIG. 5.

Simulations were performed in normal conditions, steady state fault conditions (short circuit) and maximum asymmetry fault conditions. For Cases 1-4, the same FCL 10 (having the configuration of FIG. 1) was used, with the FCL operating in a 50 Hz system and at 11 kV system voltage and 500 A normal current.

It will be appreciated that, in a system with significantly large inductance compared to resistance (e.g. X/R ratio >10) the fault condition will include a degree of asymmetry. For example, if the fault occurs at the instant in which the system voltage is maximum positive, then the fault current will be symmetric. If on the other hand the fault occurs when the system voltage is zero, the fault current will have maximum asymmetry which is manifested as a DC component superimposed on the AC component of the fault current. The presence of resistance in the circuit, causes this DC component to decay over several cycles.

A maximum asymmetric fault condition therefore represents the maximum possible fault current. Not all faults have this asymmetry.

TABLE 1

| | No | Series | | Parallel + |
|---|---|---|---|---|
| | ca- | ca- | Parallel | series |
| | pacitance | pacitance | capacitance | capacitance |
| Parameter | Case 1 | Case 2 | Case 3 | Case 4 |
| Series capacitance | — | 14.45 | — | 14.45 |
| [mF] | | | | |
| Parallel | — | — | 0.909 | 0.909 |
| capacitance [mF] | | | | |
| Parallel resistance | — | — | 1 | 1 |
| [Ω] | | | | |
| Voltage drop | 109.1 | 10.8 | 116.2 | 12.6 |
| across entire FCL | | | | |
| system at 500 A | | | | |
| load [V] | | | | |
| Insertion@500 A | 1.72% | 0.17% | 1.83% | 0.20% |
| AC (490Adc) | | | | |
| Symmetric limited | 3211 | 3248 | 2289 | 2670 |
| fault current [A] | | | | |
| Symmetric fault | 53.12% | 52.63% | 66.58% | 61.02% |
| limitation | | | | |
| Limited initial | 6358 | 5396 | 5649 | 5313 |
| peak of fault | | | | |
| current [A] | | | | |
| Initial peak | 68.49% | 73.26% | 72.00% | 73.67% |
| limitation | | | | |

FIG. 7a shows a graph of the load current and voltage drop across the entire FCL is system against time for Cases 1 to 4 under normal load conditions.

FIG. 7c shows a graph of current against time for Cases 1 to 4 under steady state fault conditions (short circuit). As can be seen, the “prospective current”, which is the fault current in the absence of the FCL system, is more than the “limited current”, which is the current with the FCL in circuit. A “steady state fault” refers to a fault condition in which the positive and negative current peaks are nearly equalequal and the transient behaviour has decayed.

FIG. 7b shows a graph of current against time for Cases 1 to 4 for the maximum asymmetry fault condition. Hence, FIG. 7b shows the maximum possible fault current and first peak limitation.

As can be seen from Table 1, in Case 1, the FCL 10 provides a 1.7% voltage drop under normal conditions. Adding a series capacitance 5 (Cases 2 and 4) significantly reduces the FCL system voltage drop under normal conditions. Adding a series capacitance 5 also improves initial peak limitation. Adding a parallel capacitance 6 (Cases 3 and 4) improves symmetric fault limitation and initial peak limitation. Adding both a series capacitance 5 and a parallel capacitance 6 provides better voltage drop under normal conditions, improved symmetric fault limitation and improved initial peak limitation.

Embodiments of the invention could be used with any saturated core FCL design. For example, in a variation of the arrangement shown in FIGS. 1a and 1b, the DC coils could be placed in alternative locations. For example, the DC coils could be placed over the inner legs 20a, 20b. In such an arrangement, the first DC coil 11a could be placed over the first AC coil 21a, and the second DC coil 11b could be placed over the second AC coil 21b, or the AC coils could be placed over the DC coils. Alternatively, a single DC coil could be wound on the inner legs 20a, 20b so as to generate both the first and second DC magnetic circuits. In other arrangements, one or more permanent magnets could be used (either alone or in conjunction with DC coils) to provide the biasing.

While the above embodiments discuss a one phase arrangement, it will be appreciated that embodiments of the invention are applicable to multiple phase arrangements. For example, three FCL apparatuses as shown in any one of FIGS. 1 to 6 (or 11 to 13 or 15 discussed later) could be combined to provide a fault current limiter system for three phases, with each FCL 10 connected to a different phase of a three phase FCL supply.

Furthermore, embodiments of the invention can use an FCL that limits for more than one phase on the same saturable core. An example of such an arrangement is shown in FIGS. 8a, 8b and 8c.

FIG. 8a shows schematically a three-phase FCL 30 having a ferromagnetic core 31 comprising “short” limbs 32a and 32b (constituting “first” limbs) and “long” limbs 33a, 33b (constituting “second” limbs). Respective bias coils 34a, 34b are wound on the short limbs 32a, 32b for maintaining the core 31 in controllable saturation. The DC bias coils 34a, 34b constitute magnetic biasing means for biasing the DC magnetic circuit into saturation at normal conditions. In this and all other embodiments, this may also be achieved using permanent magnets or a combination of DC bias coils and permanent magnets.

Respective AC coils 35R, 35S, 35T, one for each phase of a 3-phase supply, are wound in mutual spatial proximity around both the long limbs 33a and 33b. The ferromagnetic core 31 may be a wound (C-core) or a stacked core and may be of constant cross-section, although this is not mandatory. The DC current in the bias coils 34a, 34b produces flux in limbs 33a, 33b in opposite directions, and the AC current in each half cycle in each phase produces flux in the limbs 33a, 33b in the same direction.

Consequently, the closed magnetic circuit for the flux produced by the DC bias current gives rise to saturation of the limbs 33a, 33b thereby achieving low impedance for AC coils 35R, 35S, 35T in normal (non-fault) conditions. At the same time, the open magnetic circuit for the flux caused by the AC currents gives rise to current-limiting capability over a wide range of fault currents. In this figure, the symbol ‘’ is used to denote start of a coil, though it will be appreciated that other embodiments could use other arrangements of the coils (e.g. having different polarity arrangements). As shown in FIG. 8a, the AC coil 35S, is wound in an opposite direction to the for AC coils 35R and 35T.

In the embodiment, shown in FIGS. 8a, 8b and 8c, the AC coils 35R, 35S, 35T are arranged asymmetrically, as a result of the AC coil 35S, being wound in an opposite direction to the for AC coils 35R and 35T. In this context, the terms “asymmetry” and “unbalanced” are equivalent.

This asymmetry also ensures that in the case of a three-phase short circuit, the magnetic circuits for the AC coils 35R, 35S, 35T are not symmetrical so that the vector sum of the voltage drops caused by fault currents in the three AC coils is not zero and the sum of the magnetic flux ensures de-saturation of the respective magnetic circuits, thus maintaining the current-limiting capability of the FCL.

It will be appreciated that if AC coils 35R, 35S, 35T were arranged perfectly symmetrically, then the insertion impedance of the FCL would be zero, due to a cancellation of the AC fluxes. However, such an arrangement would not be able to limit three phase faults, again as a result of such cancellation of the AC fluxes.

By arranging the AC coils 35R, 35S, 35T in an unbalanced (i.e. asymmetric) way, when compared to a symmetrical arrangement, the insertion impedance of the FCL is worse but the three phase fault protection is better. In such arrangements, there is therefore a trade-off between asymmetry and insertion impedance.

Furthermore, although the embodiment shown in FIGS. 8a, 8b and 8c achieves asymmetry by arranging one of the AC coils to be wound in the opposite way to the others, in other embodiments the asymmetry could be achieved in a number of different ways. For example, the coil geometries, number of turns, or the locations of the AC coils could be varied in order to achieve the required degree of asymmetry.

In the magnetic circuit shown in FIG. 8a the magnetic core is of square cross-section as shown in FIGS. 8a and 8b where FIGS. 8b and 8c are cross-sectional views taken along the lines B-B and C-C, respectively, in FIG. 8a. However, in this and other embodiments, the cross-section of the core need not be square and may, for example, be rectangular. Moreover, although the cross-section in FIG. 8a is shown as a parallelogram, this too is not a requirement of the invention and other shapes may be employed. For example, cores having circular or elliptical cross-sections may also be used. It should also be noted that the cross-section need not be uniform along the complete length of the core.

The FCL 30 could be used with capacitors as shown in FIG. 10. In the embodiment of FIG. 10, there is an FCL apparatus 1a that comprises a FCL 30, a source terminal 2R for electrically connecting the FCL 30 to a power source (not shown) of the R phase, and a load terminal 3a for electrically connecting the FCL to a load (not shown) for the R phase. In this embodiment, the AC coil 35R of the FCL 30 is electrically connected in series between the source and load terminals 2R, 3R. A series capacitance 5R is electrically connected between the source and load terminals 2R, 3R in series with the AC coil 35R of the FCL 30. There are corresponding source and load terminals 2S, 3S for the S phase and source and load terminals 2T, 3T for the T phase. In both cases, there is a series capacitance 5S between the source and load terminals.

In normal conditions the impedance of the FCL 30 will be low and will be higher in fault conditions. As the FCL 30 operates for three phases, in an asymmetric arrangement of the AC coils, each phase of the FCL 30 may have a different inductance.

It can be considered that, in normal conditions, the FCL 30 will have a first inductance for the R phase. In fault conditions, the inductance of the FCL 30 for the R phase will vary with the varying fault current. In this embodiment, impedance of the FCL 30 for the R phase at the symmetrical rms current can be considered to be a second impedance. In other embodiments, the second impedance could be the maximum impedance, minimum impedance, average impedance or any other suitable value.

In a similar way, the FCL 30 can be considered to have a third inductance for the S phase in normal conditions, and a fourth inductance for the S phase in fault conditions; and a fifth inductance for the T phase in normal conditions, and a sixth inductance for the T phase in fault conditions.

As for FIG. 3, the series capacitances 5R, 5S, 5T have a reactance value that corresponds to the normal inductances of the respective phases. In this embodiment, the series capacitance 5R has a reactance value that corresponds to the first inductance. As a result, the series capacitance 5R will compensate for at least some of the first inductance for the R phase, lowering the impendence of the fault current limiter apparatus 1a. Furthermore, the series capacitance 5S will compensate for at least some of the third inductance, and the series capacitance 5T will compensate for at least some of the fifth inductance for the T phase.

The embodiment of FIG. 10 can achieve a reduction in the insertion impedance which can help to offset the reduction in insertion impedance caused by the asymmetry of the arrangement of the AC coils. This can allow for the benefits of an asymmetrical arrangement (i.e. good three phase fault protection) with low insertion impedance.

Furthermore, a three phase FCL such as that shown in FIGS. 8a, 8b and 8c could be used with any configuration of capacitors and resistors discussed in relation to any of the embodiments of the invention. In other words, although FIG. 10 shows a series capacitance, a parallel capacitance (with or without tuning resistances), or a combination of series and parallel capacitances (with or without tuning resistances) could be used. In some embodiments, only parallel capacitances (with or without tuning resistances) could be used, without series capacitances.

In embodiments that use parallel capacitances, the parallel capacitance for the R phase can have a reactance value that is arranged to correspond to the second inductance, the parallel capacitance for the S phase can have a reactance value that is arranged to correspond to the fourth inductance, and the parallel capacitance for the T phase can have a reactance value that is arranged to correspond to the sixth inductance.

FIGS. 9a and 9b show a schematic of another configuration of FCL 100 suitable for use in embodiments of the invention. In this embodiment, the FCL 100 has a single core, and the FCL is arranged to limit fault currents for each phase of a three-phase AC supply. FIG. 9a shows a side view, whereas FIG. 9b shows an end view.

In the FCL 100 shown in FIG. 9a, there is a single core with four legs 110a, 120a, 120b and 110b aligned in the same direction, with a first yoke 130a joining one end of the four legs, and a second yoke 130b joining the other ends of the four legs. In this embodiment, the four legs 110a, 120a, 120b and 110b are aligned vertically, with the two yokes 130a, 130b aligned horizontally.

A DC coil 111a is wound around the first leg 110a, and a second DC coil 111b is wound around the fourth leg 110b (i.e. around the two outer legs). There are two AC coils connected in series for each of the three phases of the AC supply.

As shown in FIG. 9a, a first AC coil 121Ra and a second AC coil 121Rb are connected in series to the first (R) phase of the three-phase supply. The first AC coil 121Ra is wound around the second leg 120a, and the second AC coil 121Rb is wound around the third leg 120b.

A third AC coil 121Sa is connected in series to a fourth AC coil 121Sb, and the third and fourth AC coils 121Sa and 121Sb are connected to the second (S) phase of the three-phase supply. The third AC coil 121Sa is wound around the second leg 120a, and the fourth AC coil 121Sb is wound around the third leg 120b.

A fifth AC coil 121Ta is connected in series to a sixth AC coil 121Tb, and the fifth and sixth AC coils 121Ta and 121Tb are connected to the third (T) phase of the three-phase supply. The fifth AC coil 121Ta is wound around the second leg 120a, and the sixth AC coil 121Tb is wound around the third leg 120b.

The AC coils on second leg 120a are placed top to bottom as first 121Ra, third 121Sa and fifth 121Ta respectively. In other words, the first 121Ra, third 121Sa and fifth 121Ta AC coils are arranged in order on the second leg 120a.

The AC coils on third leg 120b are placed top to bottom as sixth 121Tb, fourth 121Sb and second 121Rb respectively. In other words, the AC coils on the third 120b leg are arranged in an opposite order of the R, S, T phases when compared to the second leg 120a. Other sequential arrangements of R, S and T phases may be used on the AC legs in other embodiments.

The AC coils for each of the three phases are wound in a similar way to the AC coils 21a and 21b in FIG. 1a. In other words, they are wound so as to each produce an AC magnetic circuit within the two inner limbs (second leg 120a and third leg 120b) that opposes the DC flux in one leg and supports the DC flux in the other leg, with the situation reversing in the next half cycle.

The legs and yokes have, in this embodiment, interleaved, mitred, step-lapped joints, like the first embodiment. However, other embodiments may employ different arrangements. The core is built from grain-oriented sheet steel laminations, though other embodiments could use alternative core structures.

The coils (AC and DC) are made of electrolytic grade copper in this embodiment. However, other embodiments could use alternative materials for the coils, e.g. aluminium. Furthermore, in some embodiments the AC and DC coils can be wound on circular, oval or rectangular formers.

In some embodiments that use an FCL with three sets AC coils (one of each phase) on a single core, the AC coils for each phase can be configured so that at least one of the AC coils for each phase exhibits unbalanced magnetic impedance relative to remaining ones of the AC coils for each phase.

In other words, in each triplet, two the AC coils may have the same magnetic impedance while the third is different or alternatively all three coils in each triplet may have different magnetic impedances. It should also be noted that the imbalance may be due to different self-impedances of the three AC coils or to different mutual impedances thereof. In some embodiments, the AC coils of each phase can be wound with different numbers of turns so as to achieve asymmetrical magnetic impedance. In other embodiments, the AC coils of each phase can disposed on different portions of the inner legs so as to achieve asymmetrical magnetic impedance. Furthermore, the AC coils of each phase can have different coil geometries so as to achieve asymmetrical magnetic impedance.

As for FIGS. 8a, 8b and 8c, by arranging the three AC coils in an unbalanced (i.e. asymmetric) way, when compared to a symmetrical arrangement, the insertion impedance of the FCL is worse but the three phase fault limitation is better. In such arrangements, there is therefore a trade-off between asymmetry and insertion impedance.

The arrangement of FIGS. 9a and 9b could be used in a fault current limiter apparatus of the type shown in FIG. 10, achieving the same reduction in the insertion impedance (i.e. offsetting the reduction in insertion impedance caused by the asymmetry). Furthermore, arrangement of FIGS. 9a and 9b could be used with any configuration of capacitors and resistors discussed in relation to any of the embodiments of the invention.

FIGS. 11 to 13 show a fault current limiter apparatuses 1b, 1c and 1d according to further embodiments of the invention.

FIG. 11 shows a fault current limiter apparatus 1b and corresponds to FIG. 4, with the addition of a tuning resistance 8 in parallel with the capacitance 6 and resistance 7. FIG. 12 shows a fault current limiter apparatus 1c and corresponds to FIG. 5, with the addition of a tuning resistance 8 in parallel with the capacitance 6 and resistance 7. FIG. 13 shows a fault current limiter apparatus 1d and corresponds to FIG. 6, with the addition of a tuning resistance 8 in parallel with the capacitance 6 and resistance 7.

In all of FIGS. 11 to 13, the tuning resistance 8 (which in some embodiments can be variable) can be used to tune the bandwidth and limitation of the circuit. In other embodiments, additional resistors could be placed in other parts of the circuit. FIGS. 14a and 14b show a schematic of another configuration of FCL 200 suitable for use in embodiments of the invention.

The FCL 200 has three ferromagnetic cores 101R, 101S and 101T for each of the phases (R, S and T) of a three phase AC supply. FIG. 14b shows a top down view of the three ferromagnetic cores 101R, 101S, and 101T; while FIG. 14a shows a side view of the ferromagnetic core 101R for the R phase.

The ferromagnetic core 101R for the R phase comprises a first leg 102Ra and a second leg 102Rb. One end of the first and second legs is connected by a first yoke 103Ra and the other end of the first and second legs is connected by a second yoke 103Rb.

A first AC coil 121Ra is wound on the first leg 102Ra and a second AC coil 121Rb is wound on the second leg 102Rb, with the first and second AC coils 121Ra, 121Rb connected in series. A first DC coil 111Ra is wound around the first leg 102Ra and a second DC coil 111Rb is wound around the second leg 102Rb. In this embodiment, the DC coil on each leg is wound around the AC coil in a concentric arrangement.

The ferromagnetic cores 101S, 101T for the S and T phases are configured in a similar way. For the S phase, a first AC coil 121Sa is wound on the first leg 102Sa of the core 101S, and a second AC coil 121Sb is wound on the second leg 102Sb, with the first and second AC coils 121Sa, 121Sb connected in series. A first DC coil 111Sa is wound around the first leg 102Sa and a second DC coil 111Sb is wound around the second leg 102Sb. For the T phase, a first AC coil 121Ta is wound on the first leg 102Ta of the core 101T, and a second AC coil 121Tb is wound on the second leg 102Tb, with the first and second AC coils 121Ta, 121Tb connected in series. A first DC coil 111Ta is wound around the first leg 102Ta and a second DC coil 111Tb is wound around the second leg 102Tb.

The legs and yokes of the cores 101R, 101S and 101T have, in this embodiment, interleaved, mitred, step-lapped joints. However, other embodiments can employ simpler arrangements, using non-mitred, butt-lapped joints. The core is built from grain-oriented sheet steel laminations, though other embodiments could use alternative core structures. The coils (AC and DC) are made of electrolytic grade copper in this arrangement. However, other embodiments could use alternative materials for the coils.

The FCL 200 of this embodiment can further comprise a tank (not shown) arranged to house the three cores 101R, 101S and 101T. The tank can be partially or completely filled with a dielectric fluid. Any suitable dielectric fluid could be used, for example mineral oil or vegetable oil (which have been found to be suitable as a dielectric for voltages up to 300 kV and beyond).

In this embodiment, the two DC coils on each core provides a magnetic biasing means for that core that provides a closed magnetic circuit. The first DC coil 111Ra and the second DC coil 111Rb combine to produce a closed DC flux path inside (around) the first and second legs of each core. In this embodiment, the closed DC flux flows in a counter clockwise direction. For example, for the core 101R, the closed DC flux flows from the first DC coil 111Ra along the first leg 102Ra to the second leg 102Rb via the second yoke 103Rb then back to the first leg 102Ra via the first yoke 103Ra.

It will be appreciated that the first and second DC coils 111Sa and 111Sb will create a closed DC flux path in the S core 101S, and that the first and second DC coils 111Ta and 111Tb will create a closed DC flux path in the T core 111T in a similar way.

In this embodiment, the AC coils for each core 101R, 101S, 101T are wound so as to each produce an open AC magnetic circuit that opposes the DC flux in one leg and supports the DC flux in the other leg, with the situation reversing in the next half cycle. In other words, taking the core 101R as an example, the first AC coil 121Ra is wound on the first leg 102Ra and the second AC coil 121Rb is wound on the second leg 102Rb in the opposite sense. It will be appreciated that these AC coils may be wound in same direction but connected in appropriate way.

Hence, in first half cycle, the first AC coil 121Ra will produce flux that supports the DC flux in the first leg 102Ra and the second AC coil 121Rb will produce flux that opposes the DC flux in the second leg 102Rb. The flux from the first and second AC coils will return in open magnetic circuits.

It will be appreciated that the term “open magnetic circuit” refers to a magnetic circuit that has a path through air, as opposed to a “closed magnetic circuit” that flows through the core.

In the next half cycle, the first AC coil 121Ra will produce flux that opposes the DC flux in the first leg 102Ra and the second AC coil 121Rb will produce flux that supports the DC flux in the second leg 102Rb.

Under normal conditions, the first and second legs 102Ra, 102Rb are kept in a saturated state (with one leg being more saturated than the other leg). In fault conditions, the increase of the AC magnetic flux supporting/opposing the DC magnetic flux has the effect of (in one half cycle) putting the first leg 102Ra into very high saturation, whilst putting the second leg 102Rb into an unsaturated state (or saturated in the opposite direction to the second leg 102Rb). The effect of the second leg 102Rb being in the unsaturated state will be that the impedance of the coil on the second leg 102Rb will increase, acting to limit the fault current.

The situation in the next AC half cycle will reverse, with the first leg 102Ra being put out of saturation (and hence its impedance will rise), with the second leg 102Rb being more saturated. Hence, during fault conditions, in every half-cycle, one of the first or second legs will be out of saturation, ensuring a high impedance state. This alternation of raising impedance in the AC coils on one of the first and second legs continues until the fault is cleared.

It will be appreciated that the arrangement showing in FIGS. 14a and 14b could be used with any of the capacitor configurations shown in the embodiments discussed in relation to FIGS. 3 to 6 or 11 to 13.

FIG. 15 shows a fault current limiter apparatus 1e according to a ninth embodiment of the invention.

In this embodiment, an FCL 10 of the type discussed above in relation to FIGS. 1 and 2 is used. However, as will be discussed further below, embodiments of the invention can use any saturated core FCL configuration.

In FIG. 15, there is shown a FCL 10, a source terminal 2 for electrically connecting the FCL 10 to a power source (not shown), and a load terminal 3 for electrically connecting the FCL to a load (not shown). In this embodiment, the AC coils 21a and 21b of the FCL 10 are electrically connected in series between the source and load terminals 2, 3. A series capacitance 5 is electrically connected between the source and load terminals 2, 3 in series with the AC coils 21a, 21b of the FCL 10.

Furthermore, in this embodiment, an overvoltage protection system 9 is also provided, with the overvoltage protection system 9 being connected in parallel with the series capacitance 5. In this embodiment (as in some other embodiments), the series capacitance 5 is provided by a bank of capacitors.

The addition of the overvoltage protection system 9 connected in parallel to the series capacitance 5 helps achieve the following:
1. Reducing the size and costs of the series capacitors bank by reducing the voltage level it should bear and therefore be designed for
2. Improve steady state and rms break limitation

The overvoltage protection system 9 bypasses the series capacitance 5 above certain level of voltage. In some embodiments, this could be done continuously (though usually not linearly) or abruptly. The overvoltage protection system 9 could use a single type of overvoltage protection device or combine several types of devices such as metal-oxide varistors (MOVs), back to back diodes, spark gaps, switches, breakers, etc.

One example of such an overvoltage protection system 9 uses MOVs to clip the voltage above a certain voltage level. Another example of overvoltage protection system could use a MOV to protect the capacitors, a sparks gap to protect the MOV from excess energy and a breaker (by closing it) to protect the spark gap. These are, however, just examples, there could be several ways of using types of overvoltage protection devices separately or combined. Costs, energy levels, voltage levels, available components, etc. could dictate what way to use.

By adding the overvoltage protection system 9 the steady state and rms break fault limitation are improved (compared to using series capacitance without overvoltage protection) because the series capacitance 5 is bypassed and therefore cease to compensate for the inductive voltage drop of the FCL, that in turn improves limitation. Furthermore, such overvoltage protection systems could be used with any of the above described embodiments.

In other words, any of the above described embodiments that use series or parallel capacitances could use one or more overvoltage protection systems in parallel with in the capacitances. For example, in an embodiment that is a modification of FIG. 4, there may be an overvoltage protection system connected in parallel with the parallel capacitance 6. Similarly, in an embodiment that is a modification of FIG. 5, there may be a first overvoltage protection system connected in parallel with the series capacitance 5 and a second overvoltage protection system connected in parallel with the parallel capacitance 6.

In addition, in some embodiments, series capacitors can be used in order to compensate for line inductance. Line inductance is undesirable as it limits the capacity of power delivery on the line and causes voltage drop. The required capacitance for compensating this inductance is inversely proportional to the inductance. In other words—the higher the inductance, the lower the required capacitance. A combination of a line with an FCL in series with it, will have higher inductance compared to the line alone. This enables using lower capacitance to compensate for both the line and the FCL inductance, which improves the economic benefit of the compensation capacitors significantly. The end result is both improved FCL performance, and line compensation at lower cost.

In the above embodiments the core is built from grain-oriented sheet steel laminations, though other embodiments could use alternative core structures. The various legs and yokes have, in some embodiments, interleaved, mitred, step-lapped joints. However, other embodiments can employ simpler arrangements, using non-mitred, butt-lapped joints.

The coils (AC and DC) are made of electrolytic grade copper in this arrangement. However, other arrangement could use alternative materials for the coils.

In embodiments of the invention, the AC coils may be formed from any suitable material, such as aluminium or copper. Furthermore, the DC coils can be any suitable material, for example aluminium, copper, low temperature superconductor or a high temperature superconductor. In other embodiments, the DC coils could be replaced by a suitable DC biasing means. In other embodiments, the DC coils could be supplemented by permanent magnets.

Some embodiments employ fluid around the all or part of windings, such as mineral oil, vegetable oil or cryogenic fluid.

Some embodiments, for example for small FCLs, may employ dry type solid insulation and air around the windings with a tank/enclosure.

The AC and DC windings can have various shapes, such as circular, rectangular, oval or race-track shapes. Furthermore, the core legs and yokes can have circular (cruciform), oval or rectangular cross-section. The AC and DC coils can be wound on circular, oval or rectangular formers.

In principle, this method could be applied to any kind of saturated core FCL. It will enable limitation improvement and/or load current insertion impedance improvement, and/or size reduction. One of the advantages of the invention is using the non-linear nature inductance of the DC biased FCL to enter and depart resonance at fixed capacitance and frequency to achieve lower and higher impedances as desired in different operating regimes of the FCL.

As discussed, embodiments of the invention can provide a fault current limiter apparatus comprising: a fault current limiter including: a magnetically saturable core, at least one AC coil wound on at least a portion of the magnetically saturable core, and a magnetic biasing arrangement for magnetically biasing at least a portion of the magnetically saturable core; a source terminal for electrically connecting the fault current limiter to a power source, and a load terminal for electrically connecting the fault current limiter to a load, wherein the at least one AC coil of the fault current limiter is electrically connected between the source and load terminals, and wherein the fault current limiter has a first inductance in normal conditions and a second inductance in fault conditions; and a first capacitance electrically connected between the source and load terminals, wherein the first capacitance is electrically connected in series with the fault current limiter, and wherein the first capacitance has a capacitance that is arranged to have a reactance value that compensates for at least some of the first inductance.

In some such embodiments, the first capacitance has a capacitance that is arranged to resonate with the fault current limiter when it has the first inductance. In other embodiments, the first capacitance may have a capacitance that over or under compensates for the first inductance. Under compensation could help decreasing the impact on limitation which in some cases may be more severe than shown in the examples presented. The trade-off will be higher insertion impedance. Over compensation would be beneficial as it will decrease capacitors costs.

In some embodiments, the fault current limiter apparatus further comprises a second capacitance electrically connected between the source and load terminals, wherein the second capacitance is electrically connected in parallel with the fault current limiter, and wherein the second capacitor has a capacitance that is arranged to have a reactance value that corresponds to the second inductance.

It will be appreciated that the inductance of the FCL will vary in fault conditions. The “second inductance” could be the inductance at any point in the fault cycle. For example, the impedance of the FCL 10 at the symmetrical rms current can be considered to be a second impedance. In other embodiments, the second impedance could be the maximum impedance, minimum impedance, average impedance or any other suitable value.

In some such embodiments, a first resistance is electrically connected in series with the second capacitance, wherein the first resistance has a value arranged to tune the fault limitation of the fault current limiter apparatus.

In some embodiments, the value of the first resistance may be varied. The first resistance may be varied, for example, by adding or removing resistive elements to the circuit. This would allow tuning of the limitation of the FCL apparatus on site. This can allow the flexibility of tuning the performance after manufacturing, during testing or on site.

In some embodiments, the first capacitance is electrically connected in series to the parallel connected fault current limiter and second capacitance, and in other embodiments, the second capacitance is electrically connected in parallel to the fault current limiter and the first capacitance.

As discussed, embodiments of the invention can provide a fault current limiter apparatus comprising: a fault current limiter including: a magnetically saturable core, at least one AC coil wound on at least a portion of the magnetically saturable core, and a magnetic biasing arrangement for magnetically biasing the at least a portion of the magnetically saturable core; a source terminal for electrically connecting the fault current limiter to a power source, and a load terminal for electrically connecting the fault current limiter to a load, wherein the at least one AC coil of the fault current limiter is electrically connected between the source and load terminals, and wherein the fault current limiter has a first inductance in normal conditions and a second inductance in fault conditions; a first capacitance electrically connected between the source and load terminals, wherein the first capacitance is electrically connected in parallel with the fault current limiter, and wherein the first capacitance has a capacitance that is arranged to correspond to the second inductance.

In some embodiments, a first resistance is electrically connected in series with the first capacitance, wherein the first resistance has a value arranged to tune the fault limitation of the fault current limiter apparatus. In some embodiments, the value of the first resistance may be varied. This would allow tuning of the limitation and insertion impedance of the FCL apparatus on site.

In some embodiments, the fault current limiter apparatus further comprises a second capacitance electrically connected between the source and load terminals, wherein the second capacitance is electrically connected in series with the fault current limiter, and wherein the second capacitance has a capacitance that is arranged to have a reactance value that compensates for at least some of the first inductance. In some embodiments, the second capacitance has a capacitance that is arranged to resonate with the fault current limiter when it has the first inductance.

In some embodiments, the second capacitance is electrically connected in series to the parallel connected fault current limiter and first capacitance. In other embodiments, the first capacitance is electrically connected in parallel to the fault current limiter and the second capacitance.

Many further variations and modifications will suggest themselves to those versed in the art upon making reference to the foregoing illustrative embodiments, which are given by way of example only, and which are not intended to limit the scope of the invention, that being determined by the appended claims

1.-31. (canceled)

32. A fault current limiter apparatus comprising:
a fault current limiter including: a magnetically saturable core, at least one AC coil wound on at least a portion of the magnetically saturable core, and a magnetic biasing arrangement for magnetically biasing at least a portion of the magnetically saturable core;
a source terminal for electrically connecting the fault current limiter to a power source, and a load terminal for electrically connecting the fault current limiter to a load, wherein the at least one AC coil of the fault current limiter is electrically connected between the source and load terminals, and wherein the fault current limiter has a first inductance in normal conditions and a second inductance in fault conditions;
a first capacitance electrically connected between the source and load terminals, wherein the first capacitance is electrically connected in series with the fault current limiter, and wherein the first capacitance has a capacitance that is arranged to have a reactance value that compensates for at least some of the first inductance.

33. The fault current limiter apparatus of claim 32, wherein the first capacitance has a capacitance that is arranged to resonate with the fault current limiter when it has the first inductance.

34. The fault current limiter apparatus of claim 32, further comprising:
a second capacitance electrically connected between the source and load terminals, wherein the second capacitance is electrically connected in parallel with the fault current limiter, and wherein the second capacitance has a capacitance that is arranged to have a reactance value that corresponds to the second inductance.

35. The fault current limiter apparatus of claim 34, further comprising:
a first resistance electrically connected in series with the second capacitance, wherein the first resistance has a value arranged to tune the fault limitation and insertion impedance of the fault current limiter apparatus, optionally wherein the first resistance is variable.

36. The fault current limiter apparatus of claim 34, wherein the first capacitance is electrically connected in series to the parallel connected fault current limiter and second capacitance.

37. The fault current limiter apparatus of claim 34, wherein the second capacitance is electrically connected in parallel to the fault current limiter and the first capacitance.

38. The fault current limiter apparatus of claim 32, wherein the magnetically saturable core comprises:
a first leg;
a second leg, with a first AC coil wound on the second leg;
a third leg, with a second AC coil wound on the third leg, the first and second AC coils being connected in series;
a fourth leg;
wherein the first, second, third and fourth legs are arranged in order, wherein first ends of the first, second, third and fourth legs are joined by a first yoke and second ends of the first, second, third and fourth legs are joined by a second yoke;
a magnetic biasing system arranged to produce a first closed magnetic circuit in the first leg and the second leg that has a first flux direction, and to produce a second closed magnetic circuit in the fourth leg and the third leg that has a second flux direction, wherein the first flux direction opposes the second flux direction;
wherein the first and second AC coils are arranged to produce a first closed AC magnetic circuit in the second and third legs in an AC flux direction that alternates with each AC half-cycle.

39. A fault current limiter apparatus according to claim 38, wherein the first, second, third and fourth legs are orientated in the same direction, optionally wherein the first, second, third and fourth legs are arranged vertically;
wherein the first and second yokes are orientated in the same direction, optionally wherein the first and second yokes are arranged horizontally.

40. The fault current limiter apparatus of claim 38, wherein the magnetic biasing system comprises a first DC coil wound on the first leg and a second DC coil wound on the fourth leg; or
wherein the magnetic biasing system comprises a DC coil wound around the second and third legs, optionally wherein the at least one DC coil is wound around the first and second AC coils; or
wherein the magnetic biasing system comprises a first DC coil wound around the second leg and a second DC coil wound around the third leg, optionally wherein the first DC coil is wound around the first AC coil and the second DC coil is wound around the second AC coil.

41. The fault current limiter apparatus of claim 32, wherein the fault current limiter includes:
at least one first AC coil wound on at least a portion of the magnetically saturable core for a first phase of a three phase AC supply, the at least one first AC coil having the first inductance in normal conditions and the second inductance in fault conditions;
at least one second AC coil wound on at least a portion of the magnetically saturable core for a second phase of the three phase AC supply, the at least one second AC coil having a third inductance in normal conditions and a fourth inductance in fault conditions; and
at least one third AC coil wound on at least a portion of the magnetically saturable core for a third phase of a three phase AC supply, the at least one third AC coil having a fifth inductance in normal conditions and a sixth inductance in fault conditions;
wherein the source terminal is for electrically connecting the at least one first AC coil to the first phase of the AC supply, wherein the load terminal for electrically connecting the at least one first AC coil to a load, wherein the first capacitance is electrically connected between the source and load terminals in series with the at least one first AC coil, and wherein the first capacitance has a capacitance that is arranged to have a reactance value that compensates for at least some of the first inductance;
wherein the fault current limiter apparatus further comprises a second source terminal for electrically connecting the at least one second AC coil to the second phase of the AC supply, a second load terminal for electrically connecting the at least one second AC coil to a load, and a third capacitance electrically connected between the second source and load terminals in series with the at least one second AC coil, wherein the third capacitance has a capacitance that is arranged to have a reactance value that compensates for at least some of the third inductance; and
wherein the fault current limiter apparatus further comprises a third source terminal for electrically connecting the at least one third AC coil to the third phase of the AC supply, a third load terminal for electrically connecting the at least one third AC coil to a load, and a fourth capacitance electrically connected between the third source and load terminals in series with the at least one third AC coil, wherein the fourth capacitance has a capacitance that is arranged to have a reactance value that compensates for at least some of the fifth inductance.

42. The fault current limiter apparatus of claim 41, further comprising:
a second capacitance electrically connected between the source and load terminals, wherein the second capacitance is electrically connected in parallel with the fault current limiter, and wherein the second capacitance has a capacitance that is arranged to have a reactance value that corresponds to the second inductance;
wherein the second capacitance is electrically connected between the source and load terminals in parallel with the at least one first AC coil, wherein the second capacitance has a capacitance that is arranged to have a reactance value that is arranged to correspond to the second inductance; and wherein the fault current limiter apparatus further comprises:
a fifth capacitance electrically connected between the second source and load terminals in parallel with the at least one second AC coil, wherein the fifth capacitance has a capacitance that is arranged to have a reactance value that is arranged to correspond to the fourth inductance; and
a sixth capacitance electrically connected between the third source and load terminals in parallel with the at least one third AC coil, wherein the sixth capacitance has a capacitance that is arranged to have a reactance value that is arranged to correspond to the sixth inductance.

43. A fault current limiter apparatus comprising:
a fault current limiter including: a magnetically saturable core, at least one AC coil wound on at least a portion of the magnetically saturable core, and a magnetic biasing arrangement for magnetically biasing the at least a portion of the magnetically saturable core;
a source terminal for electrically connecting the fault current limiter to a power source, and a load terminal for electrically connecting the fault current limiter to a load, wherein the at least one AC coil of the fault current limiter is electrically connected between the source and load terminals, and wherein the fault current limiter has a first inductance in normal conditions and a second inductance in fault conditions;
a first capacitance electrically connected between the source and load terminals, wherein the first capacitance is electrically connected in parallel with the fault current limiter, and wherein the first capacitance has a reactance that is arranged to correspond to the second inductance.

44. The fault current limiter apparatus of claim 43, further comprising:
a first resistance electrically connected in series with the first capacitance, wherein the first resistance has a value arranged to tune the fault limitation and insertion impedance of the fault current limiter apparatus, optionally wherein the first resistance is variable.

45. The fault current limiter apparatus of claim 43, further comprising:
a second capacitance electrically connected between the source and load terminals, wherein the second capacitance is electrically connected in series with the fault current limiter, and wherein the second capacitance has a capacitance that is arranged to have a reactance value that compensates for at least some of the first inductance.

46. The fault current limiter apparatus of claim 45, wherein the second capacitance has a capacitance that is arranged to resonate with the fault current limiter when it has the first inductance.

47. The fault current limiter apparatus of claim 45, wherein the second capacitance is electrically connected in series to the parallel connected fault current limiter and first capacitance.

48. The fault current limiter system of claim 45, wherein the first capacitance is electrically connected in parallel to the fault current limiter and the second capacitance.

49. The fault current limiter apparatus of claim 43, wherein the magnetically saturable core comprises:
a first leg;
a second leg, with a first AC coil wound on the second leg;
a third leg, with a second AC coil wound on the third leg, the first and second AC coils being connected in series;
a fourth leg;
wherein the first, second, third and fourth legs are arranged in order, wherein first ends of the first, second, third and fourth legs are joined by a first yoke and second ends of the first, second, third and fourth legs are joined by a second yoke;
a magnetic biasing system arranged to produce a first closed magnetic circuit in the first leg and the second leg that has a first flux direction, and to produce a second closed magnetic circuit in the fourth leg and the third leg that has a second flux direction, wherein the first flux direction opposes the second flux direction;
wherein the first and second AC coils are arranged to produce a first closed AC magnetic circuit in the second and third legs in an AC flux direction that alternates with each AC half-cycle.

50. A fault current limiter system comprising:
n fault current limiter apparatuses according to claim 32, wherein the source terminal of each fault current limiter apparatus is for electrical connection to a different phase AC source.

51. The fault current limiter system of claim 50, comprising:
a first fault current limiter apparatus according to claim 32, wherein the source terminal of the first fault current limiter apparatus is for electrical connection to a first phase AC source;
a second fault current limiter apparatus according to claim 32, wherein the source terminal of the second fault current limiter apparatus is for electrical connection to a second phase AC source;
a third fault current limiter apparatus according to claim 32, wherein the source terminal of the third fault current limiter apparatus is for electrical connection to a third phase AC source.
